(19) United States
(12) Patent Application Publication
(10) Pub. No.: US 2010/0049747 A1
(43) Pub. Date: Feb. 25, 2010

(54) APPARATUS AND METHOD FOR STORING LOG IN A THREAD ORIENTED LOGGING SYSTEM

(75) Inventors: Won-Jong YANG, Hwaseong-si (KR); Sang-Gil Cho, Suwon-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/543,884

(22) Filed: Aug. 19, 2009

(30) Foreign Application Priority Data
Aug. 19, 2008 (KR) 10-2008-0080709

(51) Int. Cl. G06F 17/30

(52) U.S. Cl. 707/200; 707/E17.044

(57) ABSTRACT

An apparatus and a method for storing a log in a thread oriented logging system are provided. In the method, a name designating a storage location of a log message is set in each of at least one thread. The log message for each of the at least one thread is recorded in the storage location designated by the set name.

### PRIORITY

This application claims priority under 35 U.S.C. §119(a) to a Korean patent application filed in the Korean Intellectual Property Office on Aug. 19, 2008 and assigned Serial No. 10-2008-0080709, the entire disclosure of which is incorporated herein by reference.

### BACKGROUND OF THE INVENTION

1. Field of the Invention

The present invention relates generally to an apparatus and method for storing a log in a thread oriented logging system, and in particular, to an apparatus and method for assigning a name to a thread to store a log corresponding to a transaction of the thread for each process, each distribution object, or each thread.

2. Description of the Related Art

In a software operating system, processes, objects, and threads are mixed, while various systems process numerous operations. For example, since a web service system or a distribution object system generates a thread in response to each user request and performs a transaction for the relevant request from the beginning to the end as illustrated in FIG. 1, when a plurality of user requests occur simultaneously, a plurality of corresponding threads thereof are simultaneously generated. Here, since the simultaneously generated plurality of threads may perform similar business logic, when each of the threads processes a corresponding user request, the same object may be used frequently and repeatedly.

The web service system or the distribution object system records/stores data, a command, and results processed over time for each process or each distribution object as illustrated in FIGS. 2 to 4, thereby allowing a system operator to trace transactions that have been performed in the system. At this point, the recorded/stored data is called a log message. For example, as illustrated in FIG. 2, a computing system 200 has log files 222, 224, and 226 for respective processes 202, 204, and 206 to store log messages of threads R, G, and B, respectively. Threads R, G, and B are generated in response to requests of external systems R 212, G 214, and B 216. The computing system 200 stores log messages of threads R, G, and B for objects included in a process X 202 in a log file Log of Process X 222, and stores log messages of threads R, G, and B for objects included in a process Y 202 in a log file Log of Process Y 224. In addition, as illustrated in FIG. 3, in a computing system 300 where each distribution object exists in a separate process, the computing system 300 may have a log file 332, 334, and 336 for each distribution object 312, 314, and 316 to store log messages of threads R, G, and B generated in response to requests of external systems R 322, G 324, and B 326 in log files 332, 334, and 336 of distribution objects, respectively. In addition, as illustrated in FIG. 4, in a computing system 400 where each distribution object exists in one process, the computing system 400 may have a log file 432 for the one process 402 to store log messages of threads R, G, and B generated in response to requests of external systems R 422, G 424, and B 426. At this point, the physical location of each object is not important, and each object operates with a name given to the each object.

As described above, in the conventional thread oriented system, since all log messages for a plurality of threads are recorded on one file that records a log message of a process or a distribution object, a system operator cannot easily trace only a log message for a thread desired by the system operator. For example, in the case of tracing a log message for a specific thread, log files of a plurality of processes or distribution objects existing inside the system must be searched one by one. In addition, in the case of a roll-back system based on the log message, searching for only an operation performed by a specific thread, from numerous log messages for a plurality of threads, may result in a burden on the system. More particularly, in large-scale software systems, developers spend large amounts of time in tracing and testing only a particular log message to move, add, and delete an existing logic, which primarily increases a development term. When logic of generating a log in a separate file for each thread is realized inside a class processing a service, to address the above-described problem, additional operations not related to the service must be performed.

### SUMMARY OF THE INVENTION

The present invention has been made to solve at least the above problems and/or disadvantages and to provide at least the advantages described below. Accordingly, an aspect of the present invention is to provide an apparatus and a method for storing a log in a thread oriented logging system.

Another aspect of the present invention is to provide an apparatus and a method for facilitating log message tracing in a thread oriented logging system.

Still another aspect of the present invention is to provide an apparatus and a method for recording a log message regardless of a location of a distribution object and a process in a thread oriented logging system.

Yet another aspect of the present invention is to provide an apparatus and a method for assigning a name to a thread and storing a log message corresponding to a transaction of the thread for each process, each distribution object, or each thread in a thread oriented logging system.

Further another aspect of the present invention is to provide an apparatus and a method for operating a log policy on an existing process-based log or session basis, or an object and user request basis without system stoppage by dynamically changing a log file policy during a system operation in a thread oriented logging system.

In accordance with one aspect of the present invention, a method for storing a log in a thread oriented logging system is provided. The method includes setting, by a request processor, a name designating a storage location of a log message in each of at least one thread; and recording, by a log helper, the log message for each of the at least one thread in the storage location designated by the set name.

In accordance with another aspect of the present invention, an apparatus for storing a log in a thread oriented logging system is provided. The apparatus includes a request processor for setting a name designating a storage location of a log message in each of at least one thread; and a log helper for recording the log message for each of the at least one thread in the storage location designated by the set name.

### BRIEF DESCRIPTION OF THE DRAWINGS

The above and other aspects, features and advantages of certain embodiments of the present invention will be more apparent from the following description taken in conjunction with the accompanying drawings in which:

FIG. 1 is a diagram illustrating a thread processing method of the conventional computing system;

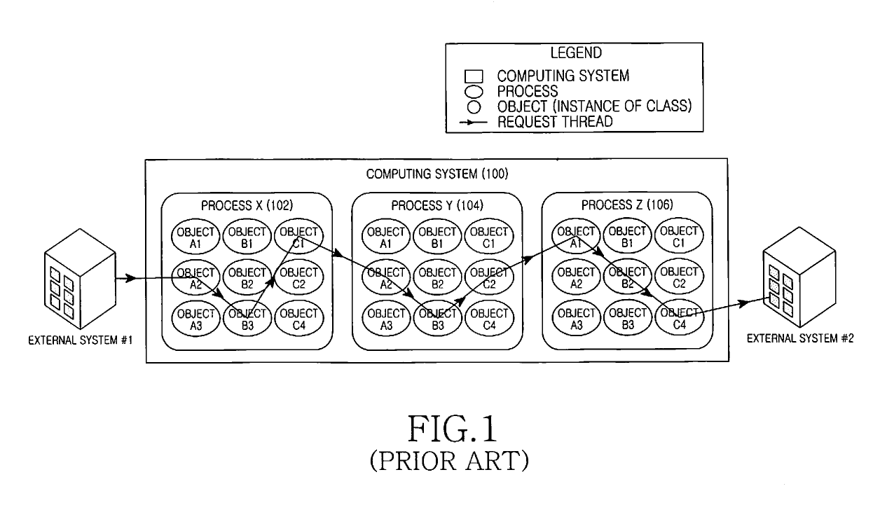

FIG. 2 is a diagram illustrating an example of recording a log message of a thread for each process in the conventional computing system;

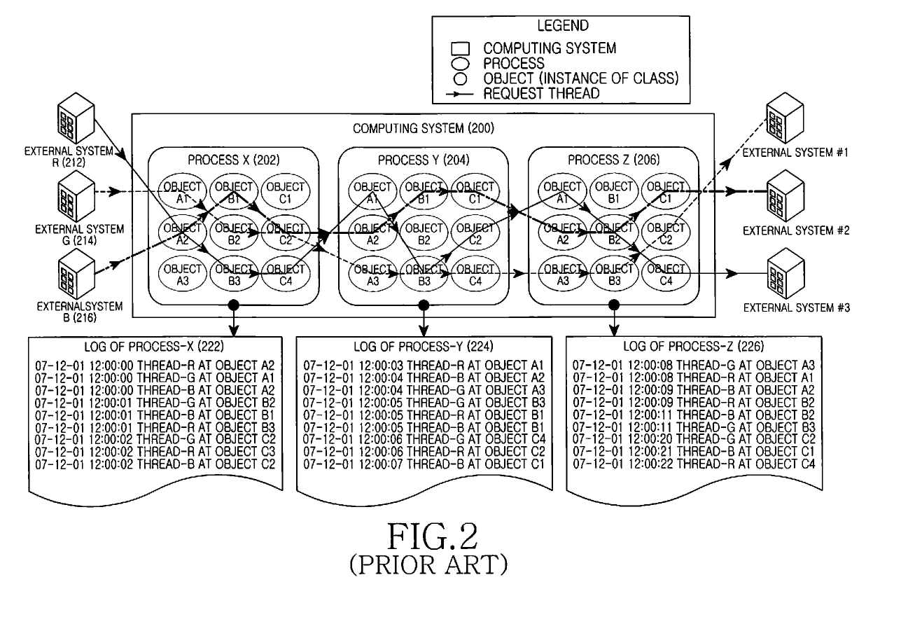

FIG. 3 is a diagram illustrating an example of recording a log message of a thread for each distribution object in the conventional computing system;

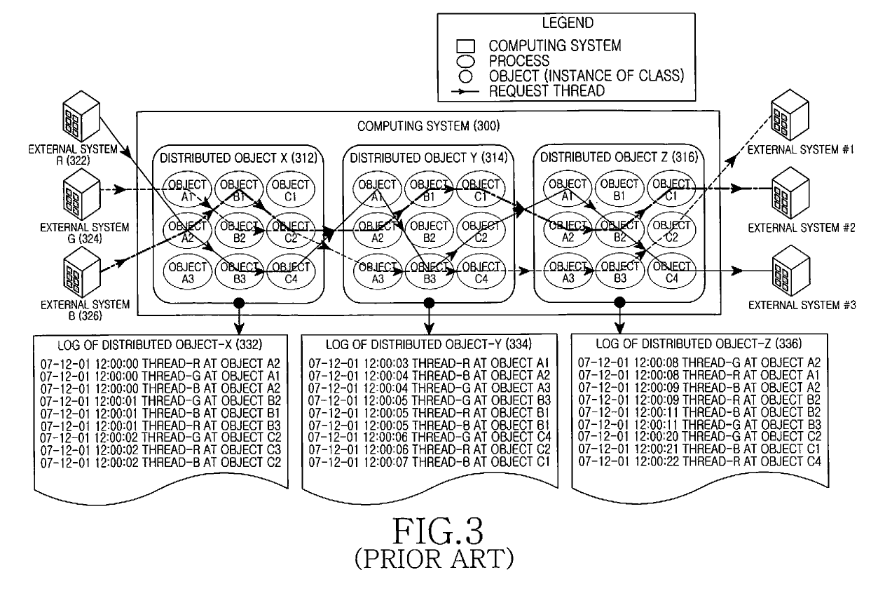

FIG. 4 is a diagram illustrating an example of recording a log message of a process including a plurality of distribution objects in the conventional computing system;

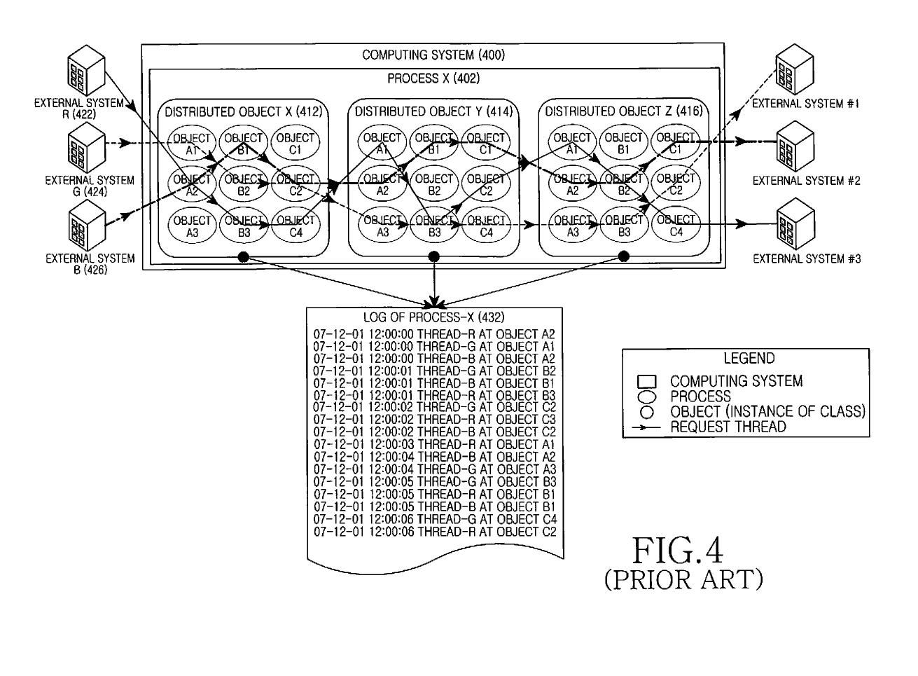

FIG. 5 is a diagram illustrating an example of recording a log message for each thread in a computing system according to an embodiment of the present invention;

FIG. 6 is a diagram illustrating an example of changing a log message recording policy in a computing system according to an embodiment of the present invention;

FIG. 7 is a block diagram for recording a log message in a computing system according to an embodiment of the present invention; and

FIG. 8 is a flowchart illustrating a method for recording a log message in a computing system according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

According to an embodiment of the present invention, log messages, which correspond to a transaction of a thread for each process, each distribution object, or each thread, are stored regardless of the location of a process or a distribution object by assigning a name to each thread and designating a location to which the log message is to be stored in a thread oriented logging system. That is, according to an embodiment of the present invention, when of storing a log message for each distribution object, a name of a relevant distribution object is assigned to a thread performing a transaction inside each respective distribution object, regardless of the location of the distribution object, so that the log message may be stored for each distribution object. This method is applied likewise to storing a log message for each process. In addition, when storing a log message for each thread, only one name may be assigned to each thread regardless of a process and a distribution object throughout a transaction process of the thread, so that a log message may be stored for each thread.

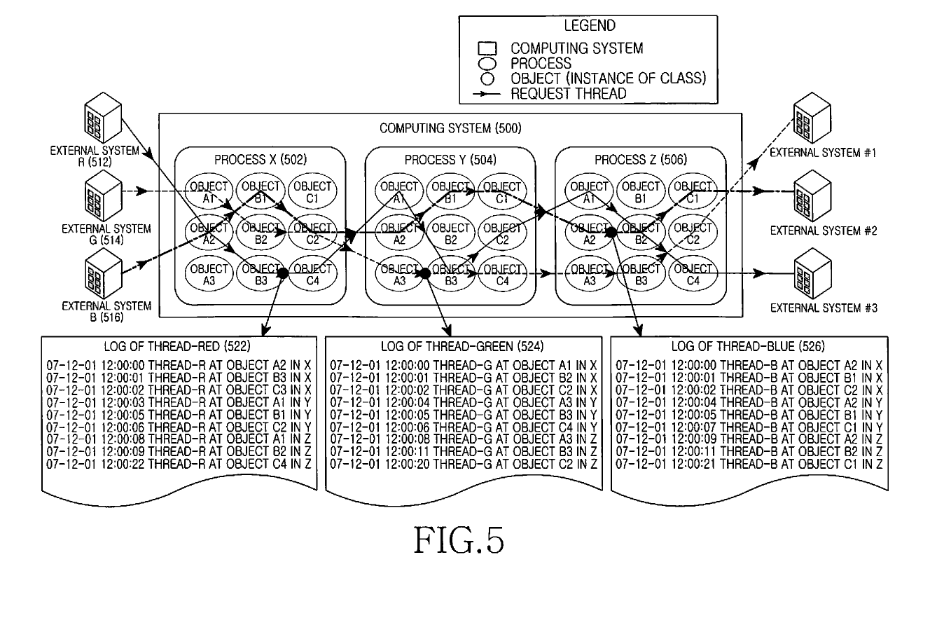

For example, according to an embodiment of the present invention, as illustrated in FIG. 5, a computing system 500 assigns thread names ‘R,’ ‘G,’ and ‘B’ to respective threads throughout transaction processes of the respective threads generated in response to requests of external systems R 512, G 514, and B 516 to allow log messages of the thread R, the thread G, and the thread B to be recorded in log files 522, 524, and 526 corresponding to their names, respectively. That is, the computing system 500 assigns only the name ‘R’ to a thread generated in response to a request of the external system R 512 throughout a transaction process to allow a log message of the thread R to be stored in a corresponding log file (Log of Thread-Red) 522.

In addition, according to an embodiment of the present invention, a logging policy may be dynamically changed during a system operation through a method of designating a location to which a log message will be stored by assigning a name to each thread. The logging policy is a policy representing a method for storing log messages for a plurality of threads. For example, the log messages may be stored for each process, for each distribution object, or for each thread. Alternatively, only a specific thread may be stored separately.

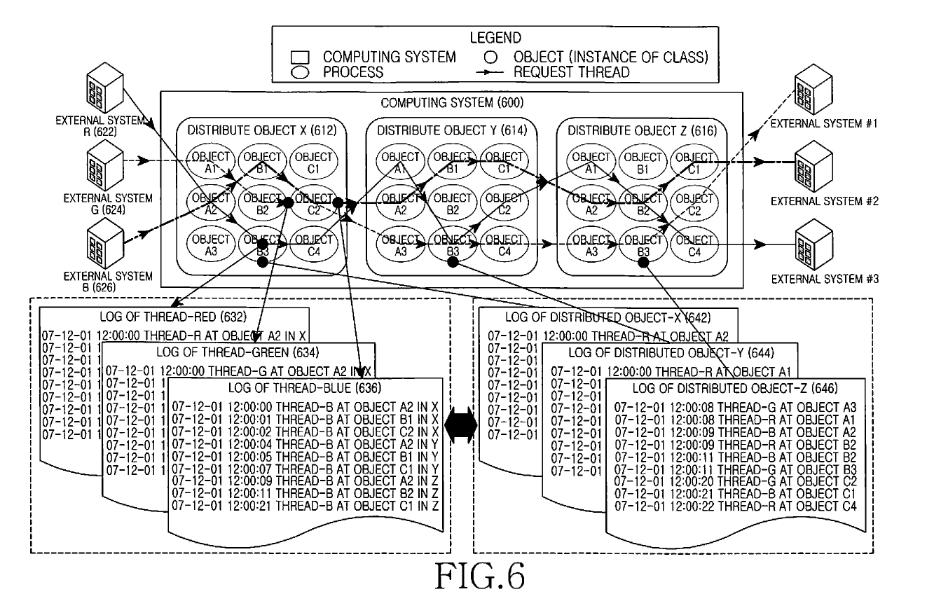

The dynamic change of the logging policy is described as follows with reference to FIG. 6. As illustrated in FIG. 6, only one name may be assigned to respective threads generated in response to respective external systems R 622, G 624, and B 626 throughout a transaction process, so that log messages are recorded in separate log files 632, 634, and 636 for each thread. Then, a method of assigning a name to a thread may be changed, so that log messages may be recorded in separate log files 642, 644, and 646 for each distribution object. That is, a computing system 600 may assign thread names ‘R,’ ‘G,’ and ‘B’ to respective threads generated in response to requests of the external systems R 622, G 624, and B 626 throughout a transaction process to store log messages of the threads R, G, and B in the corresponding log files 632, 634, and 636, and then may assign names of relevant distribution objects to the respective threads to store the log messages of the threads R, G, and B in the corresponding log files 642, 644, and 646 for each distribution object.

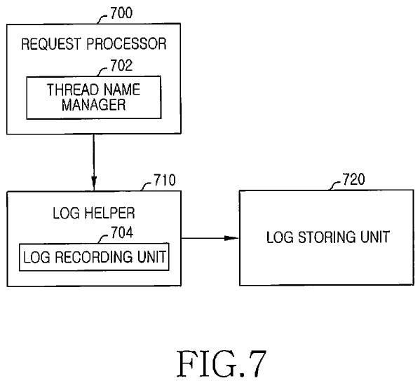

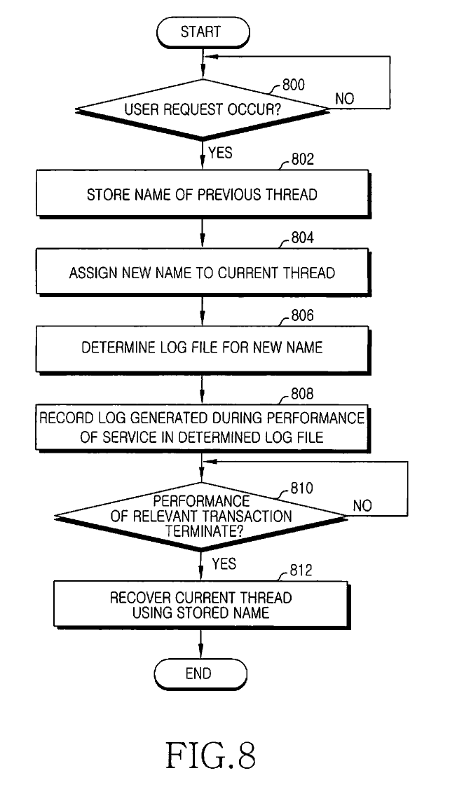

A construction and an operation of a system for storing a log message using the above-described method of assigning a name to a thread are described as follows with reference to FIGS. 7 and 8.

FIG. 7 is a block diagram of a computing system for recording a log message according to an embodiment of the present invention. Referring to FIG. 7, the computing system includes a request processor 700, a log helper 710, and a log storing unit 720. The request processor 700 includes a thread name manager 702. The log helper 710 includes a log recording unit 704.

When a user request occurs, the request processor 700 generates a thread for performing a service for the user request, and manages a transaction of the generated thread. More specifically, the request processor 700 includes the thread name manager 702 for determining a location for recording a log message for the thread, that is, a logging location.

The thread name manager 702 determines a location in which a relevant log message is to be stored through a method of assigning a name to each thread according to a logging policy. More specifically, the thread name manager 702 assigns a name, according to a logging policy, to a thread to designate a log file in which the thread is to be stored. For example, when a currently-operating logging policy is to store a log for each thread, the thread name manager 702 assigns only one name to each thread throughout a transaction process, which allows a log message for each thread to be stored in a respective log file. In addition, when a currently-operating logging policy is to store a log for each distribution object, the thread name manager 702 determines the name of a distribution object corresponding to an object to be processed by a thread, assigns the determined name of the distribution object to the thread. When the distribution object changes depending on a transaction process of a thread, the thread name manager 702 changes the name of the thread to the name of the changed distribution object to allow log messages for a plurality of threads operating inside a specific distribution object to be stored in one log file for the specific distribution object.

Here, the thread name manager 702 temporarily stores a name previously assigned to a thread in preparation for both a user request and a user response. Further, when performing a return after performance of a relevant function terminates, the thread name manager 702 assigns the temporarily stored name to the thread again to recover the previously assigned name.

The log helper 710 processes and controls an operation for recording performance information of a service performed through the thread. More specifically, the helper 710 reads a name assigned to a thread by the thread name manager 702 of the request processor 700 to determine a location in which a log message of a relevant thread is to be stored, i.e., determine a log file to be stored, and then records a log message generated during a transaction process of the relevant thread in the determined log file through the log recording unit 704.

The log storing unit 720 stores a log file, in which a log message generated during a transaction process of each thread has been recorded, and stores a log file that includes a log message separated for each process, for each distribution object, or for each thread.

FIG. 8 is a flowchart illustrating a method for recording a log message in a computing system according to an embodiment of the present invention.

Referring to FIG. 8, when a user request occurs in step 800, the computing system generates a thread to perform a service in response to the user request, temporarily stores a name previously assigned to the thread in step 802, and assigns a new name to the thread according to a logging policy of the system in step 804. Temporarily storing the name previously assigned to the thread is for recovering the previously assigned name when the computing system returns after performing a relevant function in preparation for a response to a user request.

In step 806, the computing system determines a log file in which a log message of a thread for the newly assigned name is to be stored, and records a log message generated while performing a service in the log file in step 808. When the log message is recorded, the time of the recording is automatically recorded together with the log message in the log file.

When the relevant service terminates in step 810, the computing system recovers the thread using the temporarily stored name in step 812, and ends the algorithm.

According to an embodiment of the present invention, a desired log message can be easily traced by assigning a name to a thread and storing a log message corresponding to a transaction of the thread for each process, for each distribution object, or for each thread in a thread oriented logging system. That is, in the case of assigning a name of a distribution object to a thread, even when a plurality of distribution objects exist inside one process, a log message may be separately recorded for each distribution object. Further, when assigning a name to each thread, a log message for a transaction process may be recorded for each user request. A logging policy may also change in real time to one of a process-oriented logging policy, an object-oriented logging policy, and a user request-oriented logging policy, depending on a method of assigning a name to the thread during a system operation. Further, only a log message for a specific message of a plurality of messages may be recorded in a separate file, and a web context may be assigned using a name of a thread in a web service, so that a log message may be recorded for each context.

Although the invention has been shown and described with reference to certain embodiments thereof, it will be understood by those skilled in the art that various changes in form and details may be made therein without departing from the spirit and scope of the invention as defined by the appended claims and their equivalents. Therefore, the scope of the present invention is not limited to the above-described embodiments, but by the appended claims and their equivalents thereof, and all differences within the scope will be construed as being included in the present invention.

What is claimed is:

1. A method for storing a log in a thread oriented logging system, the method comprising:
setting, by a request processor, a name designating a storage location of a log message in each of at least one thread; and
recording, by a log helper, the log message for each of the at least one thread in the storage location designated by the set name.

2. The method of claim 1, wherein the name of each of the at least one thread is changeable during a transaction process of each corresponding thread.

3. The method of claim 1, wherein only one name is set for each of the at least one thread during a transaction process of each of the at least one thread, so that a log message is stored for each of the at least one thread.

4. The method of claim 1, wherein a name of a distribution object corresponding to a transaction process of each of the at least one thread is set as the name of each of the at least one thread, respectively, so that a log message for each of the at least one thread is stored for each distribution object.

5. The method of claim 1, wherein a name of a process corresponding to a transaction process of each of the at least one thread is set as a respective name of each of the at least one thread, so that a log message for the each of the at least one thread is stored for each process.

6. The method of claim 1, wherein a previously set name of a thread is temporarily stored, such that when a service terminates in response to a user request and a return is performed, a name of a corresponding thread is recovered using the previously set name of the thread.

7. An apparatus for storing a log in a thread oriented logging system, the apparatus comprising:
a request processor for setting a name designating a storage location of a log message in each of at least one thread; and
a log helper for recording the log message for each of the at least one thread in the storage location designated by the set name.

8. The apparatus of claim 7, wherein the set name of each of the at least one thread is changeable during a transaction process of a corresponding thread.

9. The apparatus of claim 7, wherein only one name is set for each of the at least one thread during a transaction process of each of the at least one thread, so that a log message for each of the at least one thread is stored for each of the at least one thread.

10. The apparatus of claim 7, wherein a name of a distribution object corresponding to a transaction process of each of the at least one thread is set as the name of each thread, so that a log message for each of the at least one thread is stored for each distribution object.

11. The apparatus of claim 7, wherein a name of a process corresponding to a transaction process of each thread is set as the name of each of the at least one thread, so that a log message for each of the at least one thread is stored for each process.

12. The apparatus of claim 7, wherein a previously set name of a thread is temporarily stored, such that when a service in response to a user request terminates and a return is performed, a name of a corresponding thread is recovered using the previously set name of the thread.
